(19) United States
(12) Patent Application Publication
(10) Pub. No.: US 2014/0042071 A1
(43) Pub. Date: Feb. 13, 2014

(54) DEWATERING DEVICE OF VEGETABLE AND FRUIT PROCESSOR

(71) Applicant: TE-SHENG WU, Taoyuan County (TW)

(72) Inventor: TE-SHENG WU, Taoyuan County (TW)

(21) Appl. No.: 13/584,502

(22) Filed: Aug. 13, 2012

(51) Int. Cl. B01D 35/30

(52) U.S. Cl. 210/232

(57) ABSTRACT

A dewatering device of a vegetable and fruit processor is combined with a main machine that drives and rotates a filter trough and a filter to separate residues from vegetable and fruit juices. The filter trough is rotably combined into a cup body or separated from the cup body and has an accommodating chamber, a groove opening formed at the top of the accommodating chamber, a stop ring bent inwardly towards the groove opening and used with the shaft in the cup body to combine with the locking hole; the filter has a ring plate installed to the stop ring and coupled of the filter portion of the ring plate to match the filter portion with the accommodating chamber of the filter trough, the structure of the filter trough prevents the vegetable and fruit residue from spilling and can be separated quickly from the filter trough to facilitate cleaning

### FIELD OF THE INVENTION

The present invention relates to a vegetable and fruit processor, in particular to an improved design of a dewatering device of the vegetable and fruit processor capable of separating vegetable and fruit residues from vegetable and fruit juices by the centrifugal force of rotation.

### BACKGROUND OF THE INVENTION

In general, present existing vegetable and fruit processors are machines used for blending a vegetable or a fruit into a vegetable juice or a fruit juice, and the vegetable and fruit processor generally comprises a main machine, a processing cup, and a dewatering device, wherein the main machine includes a motor, a power switch and a speed switch, and further includes a first clutch installed at an upper end of the main machine; the processing cup is installed on the main machine and includes a cutter knife installed in the cup, a second clutch of the cutter knife coupled to the bottom of the cup for engaging and transmitting with the first clutch; the dewatering device comprises a cup body, a metal filter trough rotably installed in the cup body, and a third clutch installed at the bottom of the cup body and coupled to the third clutch for engaging and transmitting with the first clutch. The processing cup and the main machine are combined, so that a vegetable or a fruit can be placed into the processing cup and blended into a vegetable juice or a fruit juice, and then the processed cup is replaced by the dewatering device to be combined with the main machine, and the vegetable juice or fruit juice (including the fruit pulp) contained in the processing cup is poured into the metal filter trough, and the centrifugal force of rotation is used for separating the vegetable and fruit residue from the vegetable and fruit juice.

However, the aforementioned metal filter trough is a porous circular cylinder without any design of an appropriate mask structure to cover an opening at the top of the metal filter trough, so that when the vegetable juice or the fruit juice is poured into the metal filter trough at a high-speed rotation, the vegetable residue and the fruit pulp may spill out from the opening at the top of the metal filter trough and fall into the cup body to mix with the filtered vegetable juice or fruit juice in the cup body again. As a result, users cannot get a pure vegetable juice or fruit juice. In addition, the aforementioned conventional metal filter trough cannot be combined with or separated from the cup body easily, so that it is very difficult to clean the space or dead corners between the metal filter trough and the cup body easily after use, and dirt may be accumulated to affect the hygiene and safety.

Therefore, it is a main subject of the present invention to develop a dewatering device of a vegetable and fruit processor capable of separating the vegetable and fruit juice completely, preventing the vegetable and fruit residue from spilling out from the metal filter trough, and improving the convenience of cleaning the dewatering device.

### SUMMARY OF THE INVENTION

In the aforementioned drawbacks of the prior art, the inventor of the present invention based on years of experience un the related industry to conduct extensive researches and experiments, and finally developed a dewatering device of a vegetable and fruit processor of the invention in hope of preventing the vegetable and fruit residue from spilling out as well as separating the filter trough quickly for the cleaning purpose.

Therefore, it is a primary objective of the present invention to provide a dewatering device of a vegetable and fruit processor, wherein an improved structure composed of a filter trough and a filter is used to overcome the problem of the conventional filter trough that may spill the vegetable and fruit residue out easily during rotation, and the conventional filter trough cannot be separated easily for cleaning, so that the invention can prevent the vegetable and fruit residue from spilling out and allow users to separate the filter trough quickly for the cleaning purpose.

To achieve the aforementioned and other objectives, the present invention provides a dewatering device of a vegetable and fruit processor, comprising: a cup body, having a chamber; a filter trough, rotably combined into a chamber of the cup body, and freely detachable from the cup body, and having an accommodating chamber, a groove opening formed at the top of the accommodating chamber, a stop ring bent inwardly towards the groove opening, and a locking hole for combining with the cup body; a filter, having a ring plate installed on the stop ring, and a filter portion coupled to the ring plate and corresponding to the accommodating chamber of the filter trough; and a lid, covered onto the cup body and the filter trough.

In the dewatering device of the vegetable and fruit processor of this preferred embodiment, the filter trough is a vertical circular cylinder having a chamber formed in the accommodating chamber of the filter trough, wherein the groove opening and the stop ring are disposed at the top of the filter trough, and the bottom of the filter trough is rotably combined into the chamber of the cup body, and a plurality of filter pores is formed on a peripheral wall of the filter trough.

In the dewatering device of the vegetable and fruit processor of this preferred embodiment, the filter portion of the filter is a net bag, and an opening of the net bag is coupled to the ring plate and disposed perpendicularly in the accommodating chamber of the filter trough.

In the dewatering device of the vegetable and fruit processor of this preferred embodiment, the cup body includes a shaft with an end extended into the chamber and the other end extended outside the cup body; and the filter trough is combined to the shaft in the chamber.

In the dewatering device of the vegetable and fruit processor of the foregoing preferred embodiment, the shaft of the chamber includes a lock portion disposed at an end of the shaft, a latch portion coupled to the lock portion, and a quick-release fixing element combined with the lock portion; and the locking hole of the filter trough is sheathed on the latch portion; and the quick-release fixing element is provided for fixing the filter trough.

In the dewatering device of the vegetable and fruit processor of the foregoing preferred embodiment, the lock portion is formed on a threaded column of the shaft; and the quick-release fixing element is screwed to a quick-release nut of the threaded column

In the dewatering device of the vegetable and fruit processor of the foregoing preferred embodiment, the lid includes a through hole interconnected to the accommodating chamber of the filter trough.

Therefore, the dewatering device of the vegetable and fruit processor in accordance with the present invention can use the stop ring at the groove opening of the filter trough to achieve the effects of preventing the vegetable and fruit residue from spilling out, and providing a way for installing and combining the filter. In addition, the improved structure of combining the shaft and the filter trough can achieve the effect of separating the filter trough from the cup body to facilitate cleaning the vegetable and fruit processor.

### BRIEF DESCRIPTION OF THE DRAWINGS

FIG. 1 is an exploded view of a preferred embodiment of the present invention;

FIG. 2 is a cross-sectional view of a preferred embodiment of the present invention;

FIG. 3 is a perspective view of a preferred embodiment of the present invention; and

FIG. 4 is a schematic view of an application of a preferred embodiment of the present invention.

### DETAILED DESCRIPTION OF THE PREFERRED EMBODIMENTS

The objects, characteristics and effects of the present invention will become apparent with the detailed description of the preferred embodiments and the illustration of related drawings as follows.

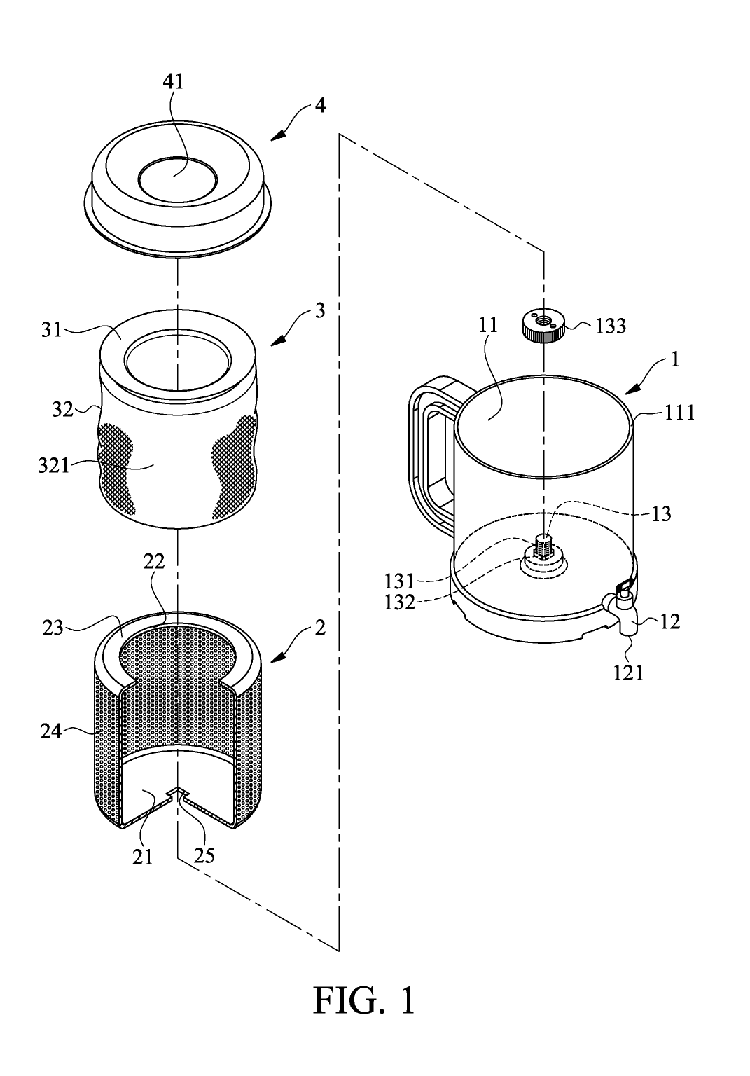

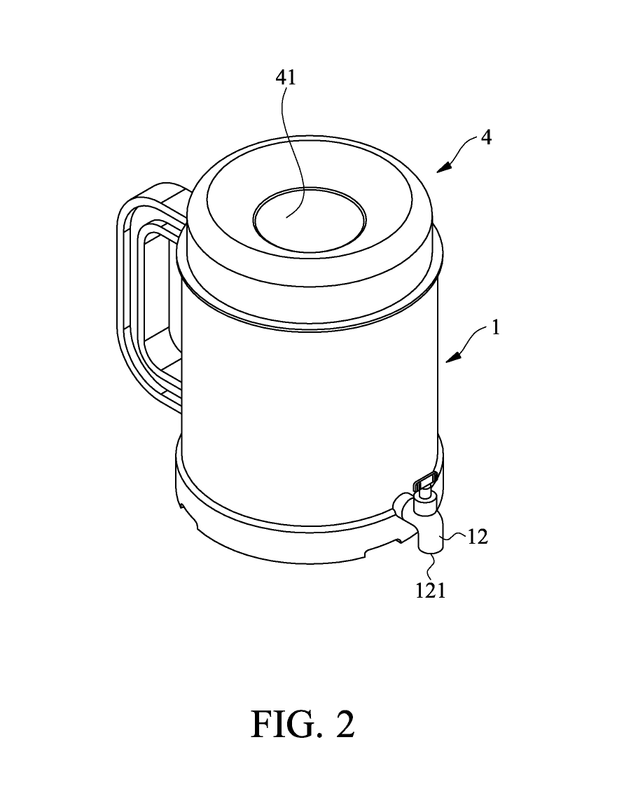

With reference to FIGS. 1 and 2 for a dewatering device of a vegetable and fruit processor in accordance with the present invention, the dewatering device comprises a cup body 1, a filter trough 2, a filter 3 and a lid 4, and the cup body 1 is combined with a main machine for use, and the main machine drives the filter trough 2 to rotate and separate the vegetable and fruit residue from the vegetable and fruit juice.

The cup body 1 is a cup provided for combining with the main machine and collecting the vegetable and fruit juice, and the cup body 1 includes a chamber 11, a liquid outlet portion 12 interconnected to the chamber 11, a shaft 13 passed into the chamber 11, a cup mouth 111 formed at the top of the chamber 11 and covered by the lid 4; the liquid outlet portion 12 is combined with a valve 121 of the cup body 1; and an end of the shaft 13 is extended into the chamber 11, and the other end of the shaft 13 is extended outside the cup body 1 for connecting and transmitting with the main machine.

The filter trough 2 is a rotating component for producing the centrifugal force to separate the vegetable and fruit juice from the vegetable and fruit residue, and the filter trough 2 is rotably combined with the shaft 13 installed in the chamber 11 of the cup body 1, and the filter trough 2 has an accommodating chamber 21, a groove opening 22 formed at the top of the accommodating chamber 21, a stop ring 23 bent inwardly towards the groove opening 22, a filter pore 24 formed on a peripheral wall of the filter trough 2, and a locking hole 25 provided for combining with the shaft 13 of the cup body 1, so that the stop ring 23 becomes a stop structure to prevent the vegetable and fruit residue from spilling from the groove opening 22 out into the cup body 1, and the locking hole 25 is used for freely combining with the cup body 1 or quickly separating from the cup body.

The filter 3 is provided filtering the vegetable and fruit juice and the vegetable and fruit residue, and the filter 3 has a ring plate 31 installed to the corresponding the stop ring 23, and a filter portion 32 coupled to the ring plate 31, so that the filter portion 32 can be matched with the accommodating chamber 21 of the filter trough 2 for filtering the vegetable and fruit residue from the vegetable and fruit juice, and the whole filter 3 can be removed from the filter trough 2 easily to facilitate disposing or recycling the vegetable and fruit residue remained in the filter 3.

The lid 4 is provided for combining with the cup mouth 111 of the cup body 1 and covered on the filter trough 2 to prevent the vegetable and fruit residue from spilling out, and a through hole 41 is formed on the lid 4 and interconnected to the accommodating chamber 21 of the filter trough 2 to facilitate users to pour the vegetable and fruit juice into the filter 3 of the filter trough 2.

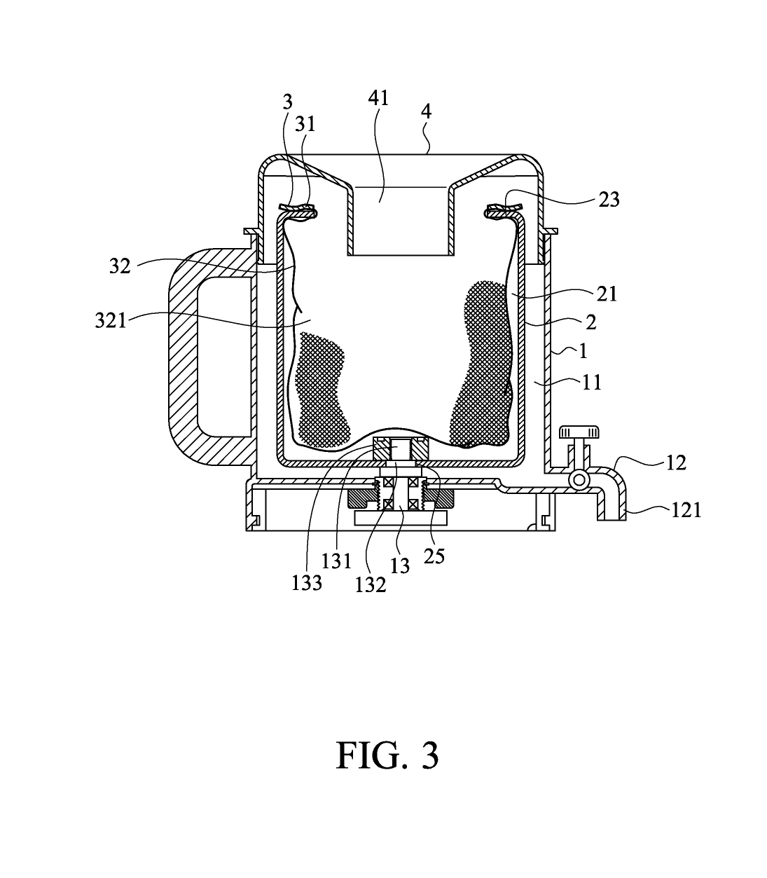

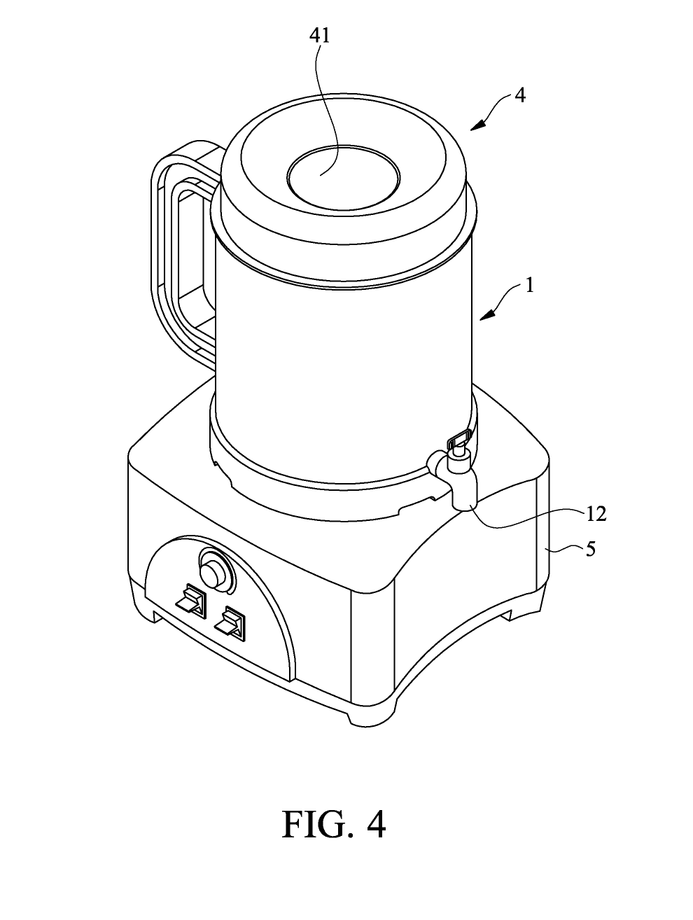

With the aforementioned structural designs of the cup body 1, the filter trough 2, the filter 3 and the lid 4, the dewatering device of the vegetable and fruit processor in accordance with the present invention as shown in FIGS. 3 and 4 includes the cup body 1 combined with a main machine 5, and a motor installed on the main machine 5 drives the filter trough 2 and the filter 3 to rotate, so that the principle of the centrifugal force separates the vegetable and fruit residue and the vegetable and fruit juice poured into the filter 3 sufficiently.

In FIGS. 1 and 2, the filter trough 2 of the present invention is a vertical circular cylinder which can be a stainless steel cylinder, and the cylinder has the accommodating chamber 21 formed therein, the groove opening 22 and stop ring 23 disposed at the top of the cylinder, and an end of the cylinder combined with a shaft 13 in the chamber 11 of the cup body 1, and the filter pore 24 formed on the peripheral wall of the cylinder. The filter portion 32 of the filter 3 of the present invention is a net bag 321, and an opening of the net bag 321 is combined with the ring plate 31, and the net bag 321 is installed perpendicularly in the accommodating chamber 21 of the filter trough 2.

In FIGS. 1 and 2, the filter trough 2 comes with a special separable design to facilitate removing the filter trough 2 for washing, and the filter trough 2 includes: a lock portion 131 formed at an end of the shaft 13 in the chamber 11 of the cup body 1, a latch portion 132 coupled to the lock portion 131, and a quick-release fixing element 133 combined with the lock portion 131, so that the locking hole 25 of the filter trough 2 can be sheathed on the latch portion 132 for selectively achieve an easy combination and separation. Wherein, the latch portion 132 is polygonal column, and the locking hole 25 is corresponsive to a polygonal hole (which is a quadrilateral hole as shown in the figure) of the polygonal column. The lock portion 131 is formed at the threaded column of the shaft 13, and the quick-release fixing element 133 is screwed to a quick-release nut of the threaded column for fixing the filter trough 2. Therefore, after the vegetable and fruit processor of the present invention is used, the quick-release fixing element 133 can be released quickly to separate the cup body 1 and the filter trough 2 for cleaning

In summation of the description above, the present invention overcomes the drawbacks of the prior art and complies with patent application requirements, and is thus duly filed for patent application.

While the invention has been described by means of specific embodiments, numerous modifications and variations could be made thereto by those skilled in the art without departing from the scope and spirit of the invention set forth in the claims.

What is claimed is:

1. A dewatering device of a vegetable and fruit processor, comprising:
a cup body, having a chamber;
a filter trough, rotably combined into a chamber of the cup body, and freely detachable from the cup body, and having an accommodating chamber, a groove opening formed at the top of the accommodating chamber, a stop ring bent inwardly towards the groove opening, and a locking hole for combining with the cup body;
a filter, having a ring plate installed on the stop ring, and a filter portion coupled to the ring plate, and corresponding to the accommodating chamber of the filter trough; and
a lid, covered onto the cup body and the filter trough.

2. The dewatering device of a vegetable and fruit processor according to claim 1, wherein the filter trough is a vertical circular cylinder having a chamber formed in the accommodating chamber of the filter trough, the groove opening and the stop ring disposed at the top of the filter trough, the bottom of the filter trough rotably combined into the chamber of the cup body, and a plurality of filter pores formed on a peripheral wall of the filter trough.

3. The dewatering device of a vegetable and fruit processor according to claim 1, wherein the filter portion of the filter is a net bag, and an opening of the net bag is coupled to the ring plate and disposed perpendicularly in the accommodating chamber of the filter trough.

4. The dewatering device of a vegetable and fruit processor according to claim 1, wherein the cup body includes a shaft with an end extended into the chamber and the other end extended outside the cup body; and the filter trough is combined to the shaft in the chamber.

5. The dewatering device of a vegetable and fruit processor according to claim 4, wherein the shaft of the chamber includes a lock portion disposed at an end of the shaft, a latch portion coupled to the lock portion, and a quick-release fixing element combined with the lock portion; and the locking hole of the filter trough is sheathed on the latch portion; and the quick-release fixing element is provided for fixing the filter trough.

6. The dewatering device of a vegetable and fruit processor according to claim 5, wherein the lock portion is formed on a threaded column of the shaft; and the quick-release fixing element is screwed to a quick-release nut of the threaded column.

7. The dewatering device of a vegetable and fruit processor according to claim 1, wherein the lid includes a through hole interconnected to the accommodating chamber of the filter trough.
